(19) United States
(12) Patent Application Publication
(10) Pub. No.: US 2011/0244283 A1
(43) Pub. Date: Oct. 6, 2011

(54) Electric Storage Module and Electric Storage Device

(75) Inventors: Sadashi SETO, Hitachinaka-shi (JP); Takatoshi Yamamoto, Hitachi-shi (JP)

(73) Assignee: Hitachi Vehicle Energy, Ltd., Hitachinaka-shi (JP)

(21) Appl. No.: 13/076,500

(22) Filed: Mar. 31, 2011

(30) Foreign Application Priority Data
Apr. 1, 2010 (JP) 2010-085115

(51) Int. Cl. H01M 10/48

(52) U.S. Cl. 429/91

(57) ABSTRACT

An electric storage module includes: a plurality of electric storage units; a casing that houses the plurality of electric storage units; a plurality of conductive members that electrically connect the plurality of electric storage units; and a voltage detection conductor that detects a voltage of each of the plurality of electric storage units, wherein: the casing includes a pair of resin side plates that hold and support at least the plurality of electric storage units from opposite sides, and the voltage detection conductor is formed so as to correspond to positions of the plurality of conductive members and placed on each of the side plates.

### INCORPORATION BY REFERENCE

The disclosure of the following priority application is herein incorporated by reference: Japanese Patent Application No. 2010-085115 filed Apr. 1, 2010.

### BACKGROUND OF THE INVENTION

1. Field of the Invention

The present invention relates to an electric storage module including a plurality of electric storage units and an electric storage device.

2. Description of Related Art

Japanese Laid-Open Patent Publication No. 2000-223160 discloses a power supply device in which a plurality of battery modules including a plurality of batteries connected in series are housed in a battery case, and a protective electronic circuit mounted to the battery case protects the batteries in the battery modules. In the power supply device described in Japanese Laid-Open Patent Publication No. 2000-223160, the plurality of battery modules are connected by bus bars and the bus bars are connected to the protective electronic circuit via fuses in order to detect a voltage of each battery module. The bus bars are insert-molded in a side plate.

### SUMMARY OF THE INVENTION

As in the device disclosed in Japanese Laid-Open Patent Publication No. 2000-223160, the number of voltage detection bus bars inserted for voltage detection increases with increasing number of batteries. Thus, voltage detection bus bars of the number corresponding to the number of batteries are inserted in the side plate, which significantly increases cost of the component.

An electric storage module according to a first aspect of the present invention comprises: a plurality of electric storage units; a casing that houses the plurality of electric storage units; a plurality of conductive members that electrically connect the plurality of electric storage units; and a voltage detection conductor that detects a voltage of each of the plurality of electric storage units, wherein: the casing includes a pair of resin side plates that hold and support at least the plurality of electric storage units from opposite sides, and the voltage detection conductor is formed so as to correspond to positions of the plurality of conductive members and placed on each of the side plates.

According to a second aspect of the present invention, the electric storage module according to the first aspect may further comprise: a securing device that secures the voltage detection conductor and each of the side plates.

According to a third aspect of the present invention, in the electric storage module according to the second aspect, the securing device may include a protrusion provided on each of the side plates, and a hole formed in the voltage detection conductor in a position corresponding to the protrusion, and the protrusion is fitted into the hole to secure the voltage detection conductor and a corresponding side plate.

According to a fourth aspect of the present invention, in the electric storage module according to the second aspect, the securing device may include a female screw provided in each of the side plates, and a hole formed in the voltage detection conductor in a position corresponding to the female screw, and the male screw is screwed into the female screw via the hole to secure the voltage detection conductor and a corresponding side plate.

According to a fifth aspect of the present invention, the electric storage module according to the first aspect may further comprise: a metal cover member that covers the casing on an outside of the pair of side plates; and a wall protruding from each of the side plates and extending along the voltage detection conductor, wherein a height of the wall from a corresponding side plate is larger than a thickness of the voltage detection conductor and smaller than a distance from the corresponding side plate to the cover member.

According to a sixth aspect of the present invention, the electric storage module according to the first aspect may further comprise: a peripheral wall protruding from each of the side plates so as to surround each of the plurality of conductive members.

According to a seventh aspect of the present invention, the electric storage module according to the fifth aspect may further comprise: a peripheral wall protruding from each of the side plates so as to surround each of the plurality of conductive members, wherein a height of the peripheral wall from a corresponding side plate is substantially equal to a height of the wall from the corresponding side plate.

According to a eighth aspect of the present invention, in the electric storage module according to the first aspect, it is preferable that the plurality of conductive members are mounted to each of the side plates from outside the casing for connecting the plurality of electric storage units.

According to a ninth aspect of the present invention, in the electric storage module according to the first aspect, it is preferable that a tip of the voltage detection conductor is connected to each of the plurality of conductive members, and a current breaking device that breaks a current from the electric storage units is provided in the voltage detection conductor.

According to a tenth aspect of the present invention, in the electric storage module according to the first aspect, it is preferable that through holes are formed in each of the side plates in positions corresponding to the plurality of electric storage units, and the plurality of electric storage units are mounted to the side plates using an adhesive member so as to tightly close the through holes.

According to a third aspect of the present invention, in the electric storage module according to the third aspect, the voltage detection conductor secured to each of the side plates may be covered with soft resin.

According to a twelfth aspect of the present invention, in the electric storage module according to the first aspect, the voltage detection conductor and the conductive members may be integrated.

An electric storage device according to a thirteenth aspect of the present invention comprises: an electric storage module according to the first aspect; and a control device that is connected to the voltage detection conductor to detect a voltage of the plurality of electric storage units and control an electric storage amount of the plurality of electric storage units.

### BRIEF DESCRIPTION OF THE DRAWINGS

FIG. 1 is a block diagram showing a configuration of an on-vehicle electric machinery system using an electric storage module according to an embodiment of the present invention;

FIG. 2 is a perspective view showing an overall appearance configuration of a lithium ion battery device according to an embodiment of the present invention;

FIG. 3 is a perspective view of the lithium ion battery device in FIG. 2 viewed from a cooling medium inlet side;

FIG. 4 is a perspective view showing an overall appearance configuration of one battery block of a battery module that constitutes the lithium ion battery device according to the embodiment;

FIG. 5 is an exploded perspective view of the battery block in FIG. 4;

FIG. 6 shows a configuration of a voltage detection conductor;

FIG. 7 is a partial enlarged view of a state where the voltage detection conductor is placed on a side plate;

FIG. 8 is a sectional view taken along the line A-A in FIG. 7 showing the state where the voltage detection conductor is placed on the side plate;

FIG. 9 is a sectional view taken along the line A-A in FIG. 7 showing the state where the voltage detection conductor is placed on the side plate;

FIG. 10 is a sectional view taken along the line B-B in FIG. 7 showing the state where the voltage detection conductor is placed on the side plate;

FIG. 11 shows a state where a conductive member is mounted to the side plate;

FIG. 12 is a flowchart illustrating a production procedure of the lithium ion battery device;

FIG. 13 is a partial enlarged view of the state where the voltage detection conductor is placed on the side plate;

FIG. 14 is a partial enlarged perspective view of a side plate having a peripheral wall surrounding an entire periphery of the conductive member; and

FIG. 15 shows a state where the voltage detection conductor and the conductive member are integrally molded.

### DESCRIPTION OF PREFERRED EMBODIMENTS

Now, an electric storage module and an electric storage device according to an embodiment of the present invention will be described with reference to the drawings.

An example of a case will be described below where the electric storage module according to the embodiment is applied to an electric storage device that constitutes an on-vehicle power supply device of an electric vehicle, particularly, an electric automobile. The electric automobile includes a hybrid electric automobile including an engine as an internal combustion engine and a motor as drive sources of the automobile, and a genuine electric automobile including a motor as an only drive source of the automobile, or the like.

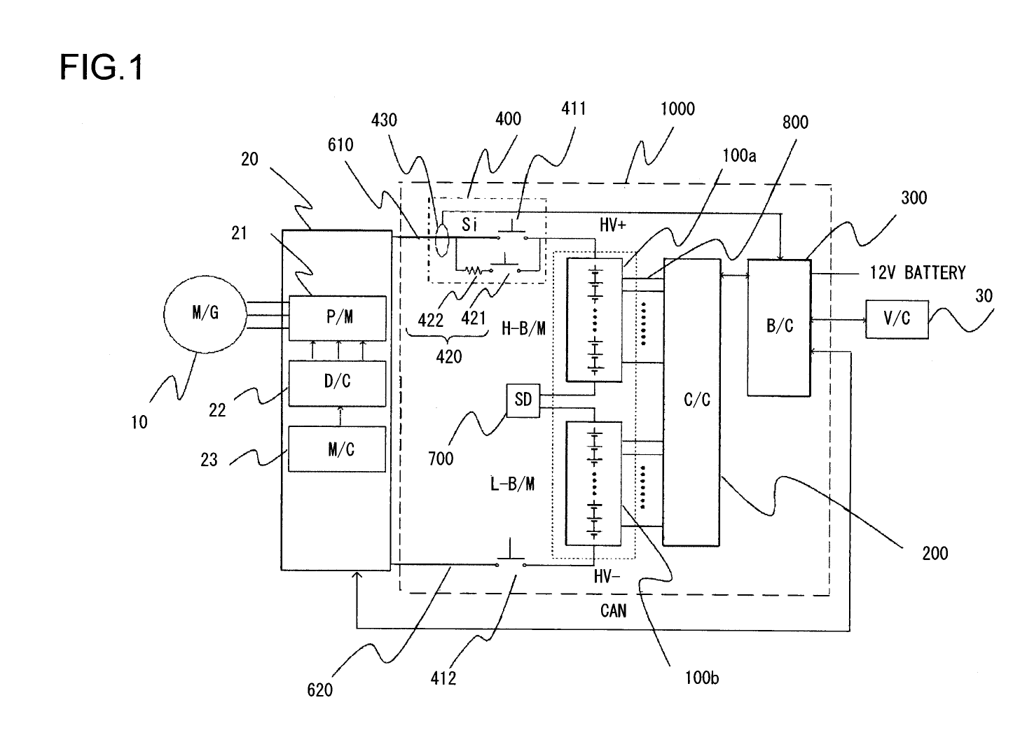

First, with reference to FIG. 1, a configuration of an on-vehicle electric machinery system (motor drive system) including the electric storage module according to the embodiment will be described.

The on-vehicle electric machinery system includes a motor generator 10, an inverter device 20, a vehicle controller 30 that controls the entire vehicle, an electric storage device 1000 that constitutes an on-vehicle power supply device, or the like. The electric storage device 1000 includes a plurality of electric storage units, and is configured as, for example, a lithium ion battery device including a plurality of lithium ion battery cells.

The motor generator 10 is a three-phase AC synchronous machine. The motor generator 10 performs motor driving in an operation mode that requires rotational power such as in power running of the vehicle and when an engine as an internal combustion engine is started, and supplies generated rotational power to driven members such as wheels and the engine. In this case, the on-vehicle electric machinery system converts DC power from the lithium ion battery device 1000 into three-phase AC power via an inverter device 20 as a power conversion device and supplies the three-phase AC power to the motor generator 10.

The motor generator 10 operates as a generator by a drive force from the wheels or the engine to generate three-phase AC power in an operation mode that requires power generation such as in regeneration during, for instance, deceleration or braking of the vehicle and when the lithium ion battery device 1000 needs to be charged. In this case, the on-vehicle electric machinery system converts three-phase AC power from the motor generator 10 into DC power via the inverter device 20 and supplies the DC power to the lithium ion battery device 1000. Thus, power is stored in the lithium ion battery device 1000.

The inverter device 20 is an electronic circuit device that controls the power conversion, that is, conversion from the DC power to the three-phase AC power and conversion from the three-phase AC power to the DC power in response to an operation (on/off) of a switching semiconductor device. The inverter device 20 includes a power module 21, a driver circuit 22, and a motor controller 23.

The power module 21 is a power conversion circuit that includes six switching semiconductor devices, and performs the power conversion according to switching operations (on/off) of the six switching semiconductor devices.

In the power module 21, a DC positive module terminal is electrically connected to a DC positive external terminal, and a DC negative module terminal is electrically connected to a DC negative external terminal. The DC positive external terminal and the DC negative external terminal are power supply side terminals for supplying and receiving DC power to and from the lithium ion battery device 1000, and power supply cables 610 and 620 extending from the lithium ion battery device 1000 are electrically connected to the DC positive external terminal and the DC negative external terminal. An AC module terminal is electrically connected to an AC external terminal. The AC external terminal is a load terminal for supplying and receiving three-phase AC power to and from the motor generator 10, and a load cable extending from the motor generator 10 is electrically connected to the AC external terminal.

The motor controller 23 is an electronic circuit device for controlling switching operations of the six switching semiconductor devices that constitute the power conversion circuit. The motor controller 23 generates switching operation command signals (for example, PWM (pulse width modulation) signals) to the six switching semiconductor devices based on a torque command output from a host control device, for example, the vehicle controller 30 that controls the entire vehicle. The generated command signals are output to the driver circuit 22.

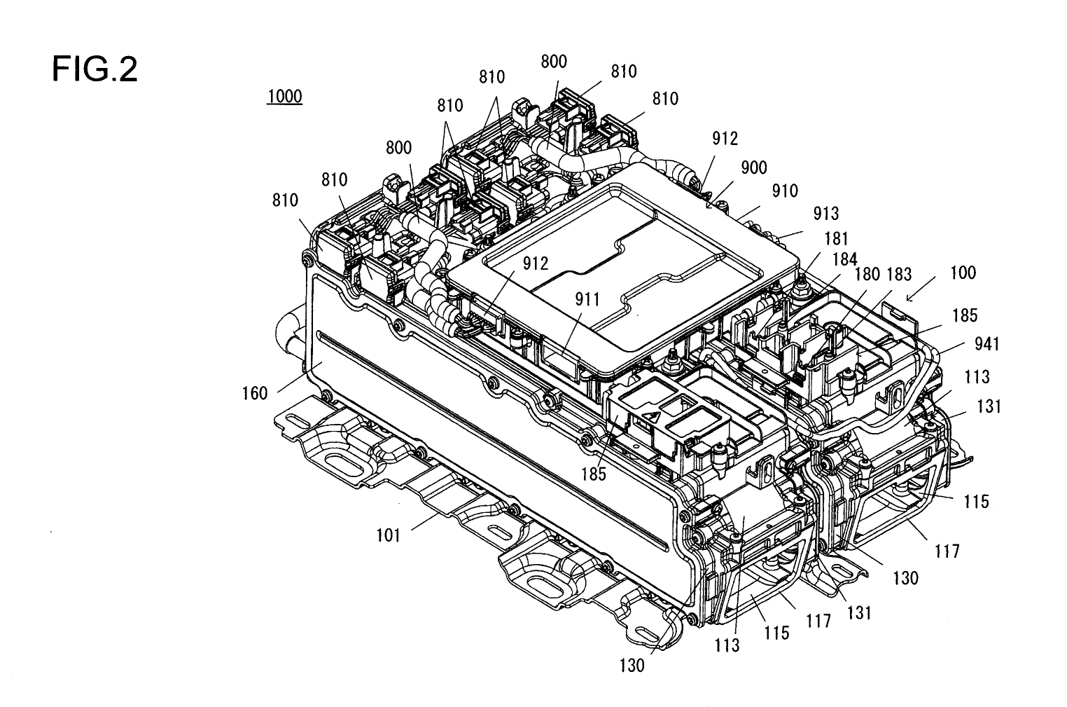

The lithium ion battery device 1000 includes a battery module (electric storage module) 100 for storing and discharging electric energy, i.e., for charging and discharging DC power, and a control device 900 (see FIG. 2) for managing and controlling a state of the battery module 100.

The battery module 100 includes two battery blocks (or battery packs), that is, a high potential battery block 100a and a low potential battery block 100b electrically connected in series. Each battery block houses assembled batteries. Each assembled battery includes a plurality of lithium ion battery cells electrically connected in series. A configuration of each battery block will be described later.

An SD (service disconnect) switch 700 is provided between a negative side (low potential side) of the high potential battery block 100a and a positive side (high potential side) of the low potential battery block 100b. The SD switch 700 is a safety device provided for ensuring safety in maintenance and inspection of the lithium ion battery device 1000, includes an electrical circuit in which a switch and a fuse are electrically connected in series, and is operated by a serviceman in maintenance and inspection.

The control device 900 includes a battery controller 300 corresponding to a host (master) controller and a cell controller 200 corresponding to a subordinate (slave) controller.

The battery controller 300 manages and controls the state of the lithium ion battery device 1000, and notifies a host control device, that is, the vehicle controller 30 or the motor controller 23, of the state of the lithium ion battery device 1000 and charge/discharge control commands of acceptable charge/discharge power. Management and control of the state of the lithium ion battery device 1000 include measurement of a voltage and a current of the lithium ion battery device 1000, calculation of an electric storage state (SOC: State of Charge) and a deterioration state (SOH: State of Health) of the lithium ion battery device 1000, measurement of temperature of each battery block, and output of commands, for example, a command for measuring a voltage of each lithium ion battery cell, and a command for adjusting an electric storage amount of each lithium ion battery cell, to the cell controller 200.

The cell controller 200 is a subordinate controller of the battery controller 300 that manages and controls states of the plurality of lithium ion battery cells according to the commands from the battery controller 300, and includes a plurality of integrated circuits (ICs). Management and control of the state of the plurality of lithium ion battery cells include measurement of a voltage of each lithium ion battery cell, and adjustment of an electric storage amount of each lithium ion battery cell. The integrated circuits correspond to the plurality of lithium ion battery cells, and manage and control states of the corresponding plurality of lithium ion battery cells.

As power supplies of the integrated circuits that constitute the cell controller 200, the corresponding plurality of lithium ion battery cells are used. Thus, the cell controller 200 and the battery module 100 are electrically connected via a connection line 800. A highest potential voltage of the corresponding plurality of lithium ion battery cells is applied to each integrated circuit via the connection line 800.

A positive terminal of the high potential battery block 100a and the DC positive external terminal of the inverter device 20 are electrically connected via the positive power supply cable 610. A negative terminal of the low potential battery block 100b and the DC negative external terminal of the inverter device 20 are electrically connected via the negative power supply cable 620.

A junction box 400 and a negative main relay 412 are provided in the middle of the power supply cables 610 and 620. The junction box 400 houses a relay mechanism including a positive main relay 411 and a precharge circuit 420. The relay mechanism is an opening/closing portion for electrical conduction and break between the battery module 100 and the inverter device 20. The relay mechanism conducts between the battery module 100 and the inverter device 20 at a startup of the on-vehicle electric machinery system, and breaks between the battery module 100 and the inverter device 20 at a stop and abnormality of the on-vehicle electric machinery system. The relay mechanism thus controls between the lithium ion battery device 1000 and the inverter device 20, thereby ensuring high safety of the on-vehicle electric machinery system.

Driving of the relay mechanism is controlled by the motor controller 23. The motor controller 23 receives notification of completion of a startup of the lithium ion battery device 1000 from the battery controller 300 at the start of the on-vehicle electric machinery system, and thus outputs a command signal for conduction to the relay mechanism to drive the relay mechanism. The motor controller 23 receives an OFF signal output from an ignition key switch at the stop of the on-vehicle electric machinery system, and receives an abnormality signal from the vehicle controller in abnormality of the on-vehicle electric machinery system, and thus outputs a command signal for break to the relay mechanism and drives the relay mechanism.

The main relay includes a positive main relay 411 and a negative main relay 412. The positive main relay 411 is provided in the middle of the positive power supply cable 610, and controls electrical connection between a positive side of the lithium ion battery device 1000 and a positive side of the inverter device 20. The negative main relay 412 is provided in the middle of the negative power supply cable 620, and controls electrical connection between a negative side of the lithium ion battery device 1000 and a negative side of the inverter device 20.

The precharge circuit 420 is a series circuit in which a precharge relay 421 and a resistor 422 are electrically connected in series, and electrically connected to the positive main relay 411 in parallel.

At the startup of the on-vehicle electric machinery system, the negative main relay 412 is first activated, and then the precharge relay 421 is activated. Thus, a current supplied from the lithium ion battery device 1000 is controlled by the resistor 422, and is then supplied to and charges a smoothing capacitor included in the inverter. After the smoothing capacitor is charged to a predetermined voltage, the positive main relay 411 is activated, and the precharge relay 421 is released. Thus, a main current is supplied from the lithium ion battery device 1000 via the positive main relay 411 to the inverter device 20.

The junction box 400 houses a current sensor 430. The current sensor 430 is provided for detecting a current supplied from the lithium ion battery device 1000 to the inverter device 20. An output line of the current sensor 430 is electrically connected to the battery controller 300. The battery controller 300 determines the current supplied from the lithium ion battery device 1000 to the inverter device 20 based on a signal output from the current sensor 430. The current detection information is notified from the battery controller 300 to the motor controller 23 or the vehicle controller 30. The current sensor 430 may be placed outside the junction box 400. A current of the lithium ion battery device 1000 may be detected at a position toward the inverter device 20 with respect to the positive main relay 411, and also at a position toward the battery module 100 with respect to the positive main relay 411.

The junction box 400 may house a voltage sensor for detecting a voltage of the lithium ion battery device 1000. In such a case, an output line of the voltage sensor is electrically connected to the battery controller 300 like the current sensor 430. The battery controller 300 determines a voltage of the entire lithium ion battery device 1000 based on an output signal of the voltage sensor. The voltage detection information is notified to the motor controller 23 or the vehicle controller 30. A voltage of the lithium ion battery device 1000 may be detected either at a position toward the battery module 100 or toward the inverter device 20 with respect to the relay mechanism.

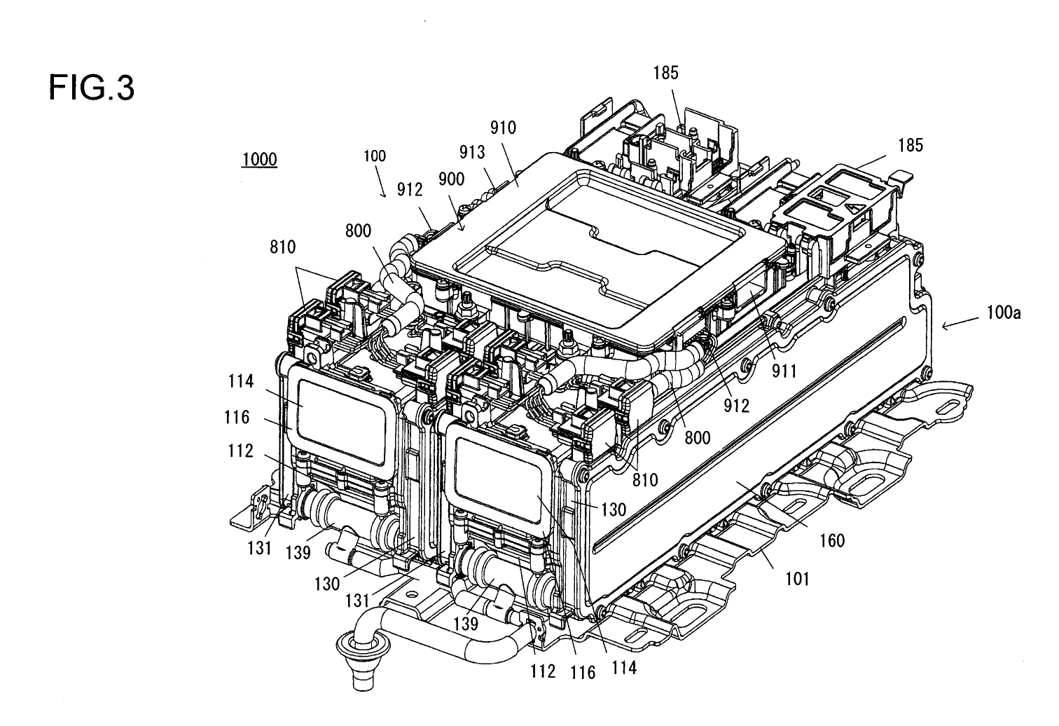

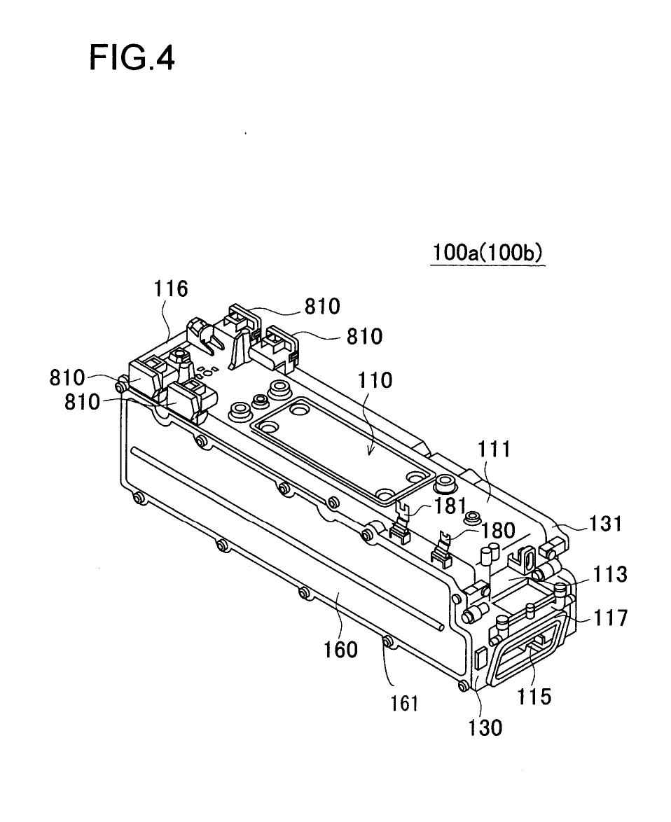

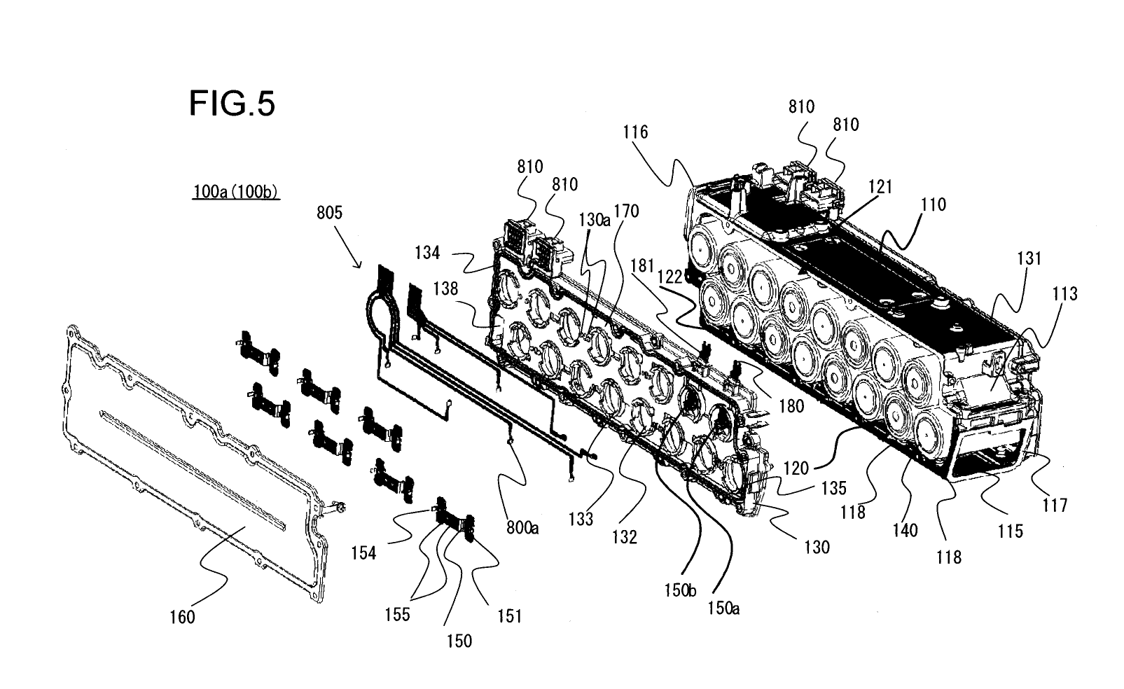

Next, with reference to FIGS. 2 to 5, a configuration of the lithium ion battery device 1000 will be described. FIGS. 2 and 3 are perspective views showing an overall configuration of the lithium ion battery device 1000. FIG. 4 is a perspective view of a battery block that constitutes the lithium ion battery device 1000, and FIG. 5 is an exploded perspective view of the battery block shown in FIG. 4.

The lithium ion battery device 1000 mainly includes two units: the battery module 100 and the control device 900. A configuration of the battery module 100 will be first described.

As described above, the battery module 100 includes the high potential battery block 100a and the low potential battery block 100b, and the two battery blocks 100a and 100b are electrically connected in series. The high potential battery block 100a and the low potential battery block 100b have the same configuration. Thus, FIGS. 4 and 5 only show the high potential battery block 100a as a representative example of the high potential battery block 100a and the low potential battery block 100b, and a description on a detailed configuration of the low potential battery block 100b will be omitted.

As shown in FIG. 2, the high potential battery block 100a and the low potential battery block 100b are placed adjacent to each other in parallel so that longitudinal directions of the blocks are parallel to each other. The high potential battery block 100a and the low potential battery block 100b are placed in parallel on a module base 101, and secured by securing means such as a bolt. The module base 101 is made of a rigid thin metal plate, for example, iron plate, divided into three parts in a lateral direction, and secured to the vehicle. Specifically, the module base 101 is formed of three members placed at both ends and a middle in the lateral direction. With such a configuration, a surface of the module base 101 can be flush with lower surfaces of the battery blocks 100a and 100b, and a size of the battery module 100 in a height direction can be further reduced.

Upper portions of the high potential battery block 100a and the low potential battery block 100b are secured by a case 910 of the control device 900 described later.

As shown in FIG. 5, the high potential battery block 100a mainly includes a casing 110 (may also be referred to as a case, housing, or package) and an assembled battery 120. The assembled battery 120 is housed and held in the casing 110.

The casing 110 constitutes a substantially hexahedral block case. Specifically, the casing 110 includes six connected members: an inlet channel forming plate 111, an outlet channel forming plate 118, an inlet guide plate 112, an outlet guide plate 113, and two side plates 130 and 131. An inner space of the casing 110 functions as a housing chamber that houses the assembled battery 120, and also functions as a cooling passage through which a cooling medium (cooling air) for cooling the assembled battery 120 passes.

In the description below, a direction of the longest side of the casing 110 and a direction from a cooling medium inlet 114 toward a cooling medium outlet 115 are defined as a longitudinal direction. On the other hand, a lateral direction is defined as a direction in which two side surfaces, i.e., two side plates 130 and 131, face each other, with the said two side surfaces being different from the two side surfaces, i.e., the inlet guide plate 112 and the outlet guide plate 113, facing each other in the longitudinal direction of the casing 110, a direction of a central axis of the lithium ion battery cell 140 (a direction of two electrodes of a positive terminal and a negative terminal facing each other), and a direction in which a conductive member 150 that electrically connects two lithium ion battery cells 140 and the two lithium ion battery cells 140 face each other. Further, a direction of the inlet channel forming plate 111 and the outlet channel forming plate 118 facing each other is defined as a height direction irrespective of an arrangement direction of the battery module 100.

The inlet channel forming plate 111 is a rectangular flat plate that forms an upper surface of the casing 110. The outlet channel forming plate 118 is a flat plate that forms a bottom surface of the casing 110. The inlet channel forming plate 111 and the outlet channel forming plate 118 are displaced from each other in the longitudinal direction. Thus, end positions in the longitudinal direction of the inlet channel forming plate 111 and the outlet channel forming plate 118 are displaced in the longitudinal direction. The inlet channel forming plate 111 and the outlet channel forming plate 118 are made of rigid thin metal plates.

The inlet guide plate 112 is a plate member that forms one of the side surfaces facing each other in the longitudinal direction of the casing 110. The outlet guide plate 113 is a plate member that forms the other of the side surfaces facing each other in the longitudinal direction of the casing 110. The inlet guide plate 112 and the outlet guide plate 113 are made of rigid thin metal plates.

Between the inlet channel forming plate 111 and the inlet guide plate 112, a cooling medium inlet 114 is formed that constitutes an introduction port of cooling air as a cooling medium into the casing 110. The cooling medium inlet 114 includes a cooling medium inlet duct 116 for guiding the cooling air to the cooling medium inlet 114. As described above, the inlet channel forming plate 111 and the outlet channel forming plate 118 are displaced from each other, and an inlet side end of the casing 110 is formed into a step shape. Thus, a space is formed between the cooling medium inlet 114 and the inlet guide plate 112 in the longitudinal direction. This space houses a gas exhaust pipe 139 described later. As shown in FIG. 3, the inlet guide plate 112 is placed behind the gas exhaust pipe 139. With such a configuration, a size of the battery module 1000 in the longitudinal direction can be reduced. Between the outlet channel forming plate 118 and the outlet guide plate 113, a cooling medium outlet 115 is formed that constitutes a discharge port of the cooling air from the inside of the casing 110. The cooling medium outlet 115 includes a cooling medium outlet duct 117 for guiding the cooling air from the cooling medium outlet 115 to the outside.

The cooling medium inlet 114 and the cooling medium outlet 115 are displaced in the height direction, that is, a direction of the inlet channel forming plate 111 and the outlet channel forming plate 118 facing each other. Specifically, the cooling medium inlet 114 is placed closer to the inlet channel forming plate 111, and the cooling medium outlet 115 is placed closer to the outlet channel forming plate 118.

In view of an assemblability of the battery block, the inlet channel forming plate 111, the outlet guide plate 113, the cooling medium inlet 114, and the cooling medium inlet duct 116 are integrally formed, and the outlet channel forming plate 118, the inlet guide plate 112, the cooling medium outlet 115, and the cooling medium outlet duct 117 are integrally formed.

The inlet channel forming plate 111, the outlet channel forming plate 118, the inlet guide plate 112, the outlet guide plate 113, the cooling medium inlet 114, and the cooling medium outlet 115 are connected with the side plates 130 and 131 by securing means such as screws, bolts, or rivets. Between the members connected at the connection areas, seal members (not shown) are provided so that airtightness in the casing 110 is increased and the cooling medium introduced from the cooling medium inlet 114 into the casing 110 is discharged from the cooling medium outlet 115 without leaking to the outside.

The side plates 130 and 131 are flat plate members that form two side surfaces facing each other in the lateral direction of the casing 110, and are molded members made of electrically insulating resin such as PBT. The side plates 130 and 131 are thicker than the inlet channel forming plate 111, the outlet channel forming plate 118, the inlet guide plate 112, and the outlet guide plate 113. Detailed configurations of the side plates 130 and 131 will be described later.

Outside the side plates 130 and 131, that is, a side opposite to the housing chamber of the assembled battery 120 with respect to the side plates, a cover member 160 referred to as a side cover is provided. FIG. 5 shows only a cover member 160 outside the side plate 130, but a cover member 160 is also provided outside the side plate 131. The cover member 160 is secured to the side plate 130 by securing means 161 such as bolt or a rivet.

The cover plate 160 is a flat plate formed by pressing a metal plate of iron or aluminum, or a flat plate formed by molding resin such as PBT, and has substantially the same shape as a plane shape of the side plate 130. In the cover plate 160, a region including areas corresponding to through holes 132 in the side plate 130 described later is uniformly expanded or deformed to a side opposite to the side plate 130. Thus, a space is formed between the cover plate 160 and the side plate 130. The space functions as a gas release chamber or a gas release passage to which a mist gas ejected from the lithium ion battery cell 140 is released and separated from the cooling medium passing through the cooling passage.

The assembled battery 120 is an assembly of the plurality of lithium ion battery cells 140, that is, a group of lithium ion battery cells. The plurality of lithium ion battery cells 140 are arranged and housed in the housing chamber formed in the casing 110, held by the side plates 130 and 131 from the lateral direction, and electrically connected in series by being joined to the plurality of conductive members 150 referred to as bus bars.

The lithium ion battery cell 140 has a cylindrical structure in which components such as a battery element and a safety valve are housed in a battery case into which an electrolyte is injected. A positive safety valve is a cleavage valve that splits when pressure in the battery case reaches a predetermined pressure by abnormality such as overcharge. The safety valve functions as a fuse mechanism that breaks electrical connection between a battery lid and a positive side of the battery element by cleavage, and also functions as a pressure reducing mechanism that ejects a gas generated in the battery case, that is, a mist carbon dioxide gas (ejection) containing the electrolyte to the outside of the battery case.

A cleavage groove is also provided on a negative side of the battery case, and splits when pressure in the battery case reaches a predetermined pressure by abnormality such as overcharge. Thus, the gas generated in the battery case can be also ejected from a negative terminal side. A nominal output voltage of the lithium ion battery cell 140 is 3.0 to 4.2 volt, and an average nominal output voltage is 3.6 volt.

In the embodiment, sixteen cylindrical lithium ion battery cells 140 are arranged and placed in the casing 110 to constitute the assembled battery 120. Specifically, eight lithium ion battery cells 140 are placed in parallel so as to lie side by side with the central axes thereof extending in the lateral direction to constitute a first battery cell row 121. Like the first battery cell row 121, eight lithium ion battery cells 140 are placed to constitute a second battery cell row 122. The assembled battery 120 is constituted by the first battery cell row 121 and the second battery cell row 122 stacked in the height direction, stacking one on top of another or between two cells. Specifically, the assembled battery 120 is constituted by eight lithium ion battery cells 140 arranged in a row in the longitudinal direction and in two steps or two tiers in the height direction.

The first battery cell row 121 and the second battery cell row 122 are displaced from each other in the longitudinal direction. Specifically, the first battery cell row 121 is displaced from the second battery cell row 122 toward the inlet channel forming plate 111 and the cooling medium inlet 114. On the other hand, the second battery cell row 122 is displaced from the first battery cell row 121 toward the outlet channel forming plate 118 and the cooling medium outlet 115. As shown in FIG. 5, in the embodiment, for example, the first battery cell row 121 and the second battery cell row 122 are displaced in the longitudinal direction so that a position in the longitudinal direction of a central axis of a lithium ion battery cell 140 located closest to the cooling medium outlet 115 in the first battery cell row 121 is located in an intermediate position between a central axis of a lithium ion battery cell 140 located closest to the cooling medium outlet 115 in the second battery cell row 122 and a central axis of an adjacent lithium ion battery cell 140 in the second battery cell row.

The lithium ion battery cells 140 that constitute the first battery cell row 121 are arranged in parallel so as to alternate their terminals. The lithium ion battery cells 140 that constitute the second battery cell row 122 are also arranged in parallel with terminals alternately directed opposite. However, an arrangement order of the terminals of the lithium ion battery cells 140 that constitute the first battery cell row 121 from the side of the cooling medium inlet 114 to the side of the cooling medium outlet 115 is different from an arrangement order of the terminals of the lithium ion battery cells 140 that constitute the second battery cell row 122. Specifically, in the first battery cell row 121, the terminals of the lithium ion battery cells 140 facing the side plate 130 are arranged from the side of the cooling medium inlet 114 to the side of the cooling medium outlet 115 in order of a negative terminal, a positive terminal, a negative terminal, . . . , and a positive terminal. On the other hand, in the second battery cell row 122, the terminals of the lithium ion battery cells 140 facing the side plate 130 are arranged from the side of the cooling medium inlet 114 to the side of the cooling medium outlet 115 in order of a positive terminal, a negative terminal, a positive terminal, . . . , and a negative terminal.

As such, the first battery cell row 121 and the second battery cell row 122 are displaced in the longitudinal direction, thereby reducing a size of the assembled battery 120 in the height direction, and reducing a size of the high potential battery block 110a in the height direction.

Next, configurations of the side plates 130 and 131 that hold the assembled battery 120 from opposite sides will be described. The configuration of only one side plate 130 will be described for simplicity, but the other side plate 131 basically has the same configuration as the side plate 130.

However, a battery module connection terminal 180 electrically connected to a positive side of the assembled battery 120 and a battery module connection terminal 181 electrically connected to a negative side of the assembled battery 120 are provided only on the side plate 130. The connection terminals 180 and 181 are juxtaposed in the longitudinal direction on an upper surface of the side plate 130, that is, a surface on the side of the inlet channel forming plate 111. A DC positive input/output terminal 183 and a negative input/output terminal 184 formed as subassemblies 185 separately from the battery module 100 are connected to the connection terminals 180 and 181. A terminal of the positive power supply cable 610 is connected to the positive input/output terminal 183 of the high potential battery block 110a, and a terminal of a cable electrically connected to one end of the SD switch 700 is connected to the negative input/output terminal 184 (see FIG. 1). A terminal of a cable electrically connected to the other end of the SD switch 700 is connected to the positive input/output terminal 183 of the low potential battery block 110b. A terminal of the negative power supply cable 620 is connected to the negative input/output terminal 184 of the low potential battery block 110b. FIG. 2 shows the subassembly 185 of the high potential battery block 100a covered with a terminal cover, and the subassembly 185 of the low potential battery block 100b with a terminal cover removed.

The side plate 130 is formed into a substantially rectangular flat plate shape as shown in FIG. 5. The side plate 130 has sixteen circular through holes 132 passing through in the lateral direction. The sixteen through holes 132 are provided in alignment with the sixteen lithium ion battery cells 140 so as to open correspondingly to electrode positions of the sixteen lithium ion battery cells 140 arranged as described above. Thus, when the assembled battery 120 is housed in the casing 110, the sixteen through holes 132 in the side plate 130 are closed by terminal surfaces on one end side of the sixteen lithium ion battery cells 140, and the sixteen through holes 132 in the side plate 131 are closed by terminal surfaces on the other end side of the sixteen lithium ion battery cells 140. As shown in FIG. 5, in the high potential battery block 100a, the side plate 130, a voltage detection conductor 805, the conductive members 150, and the cover member 160 are placed from the side of the casing 110. In assembly of the high potential battery block 100a, the side plate 130, the voltage detection conductor 805, the conductive members 150, and the cover member 160 are assembled in this order from the side of the casing 110. The voltage detection conductor 805 is placed on the side plate 130 and in contact with an outer wall surface 170 of the side plate 130 in the assembled state.

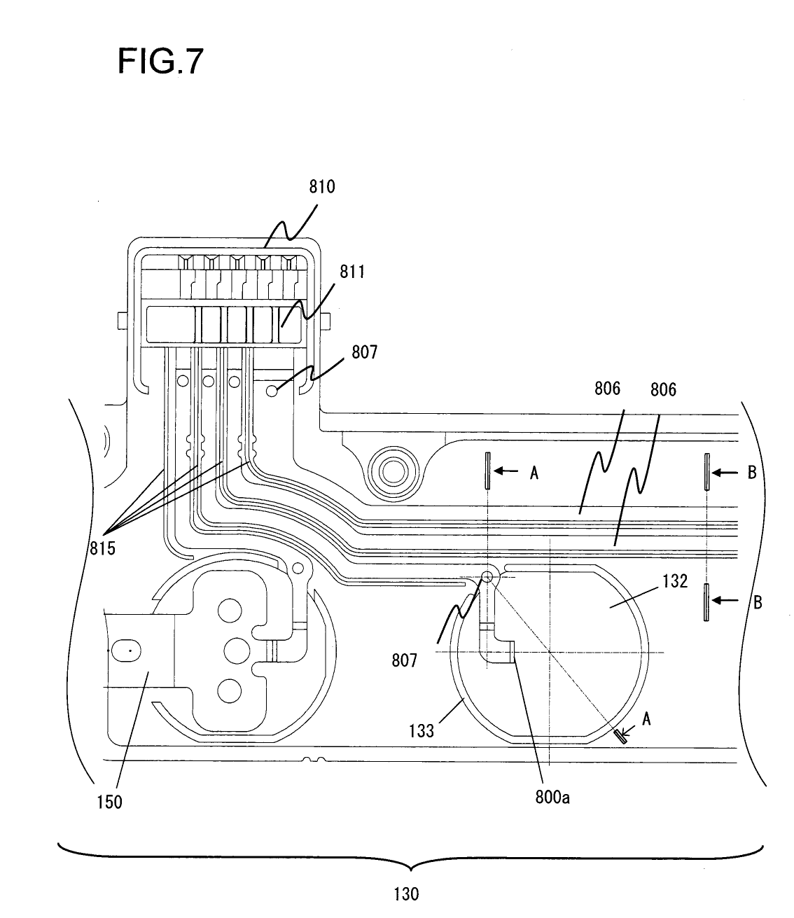

In the side plate 130, on the outer wall surface 170 on the side opposite to an inner wall surface that forms the housing chamber of the assembled battery 120, a protrusion (peripheral wall) 133 is formed so as to surround each through hole 132. Further, on the outer wall surface 170, a plurality of securing guides 130a for placing the conductive members 150 to be connected to the lithium ion battery cells 140 are formed between the through holes 132. The peripheral walls 133, the securing guides 130a, and walls 815 (see FIGS. 7, 8 and 9) protrude from the outer wall surface 170 to prevent contact between the cover member 160 and the conductive members 150 or the voltage detection conductor 805. Thus, when the cover member 160 is formed of, for example, a flat plate of metal such as iron, a short circuit between the cover member 160 and the conductive members 150 or the voltage detection conductor 805 can be prevented.

In the side plate 130, a gas exhaust passage 138 is provided for exhausting a gas (a gas with a mixture of a liquid containing an electrolyte and gas) released to the gas release chamber between the side plate 130 and the cover member 160 to the outside of the high potential battery block 100a. An opening of the gas exhaust passage 138 is formed in a lower portion of the side plate 130 in view of discharge of the liquid such as electrolyte contained in the said gas. Specifically, the opening is formed in the side plate 130 at a position closer to the cooling medium inlet 140 and the outlet channel forming plate 118. A tip of the gas exhaust passage 138 is formed into a pipe shape, to which a gas exhaust pipe 139 (see FIG. 3) for guiding the gas exhausted from the gas exhaust passage 138 to the outside is connected.

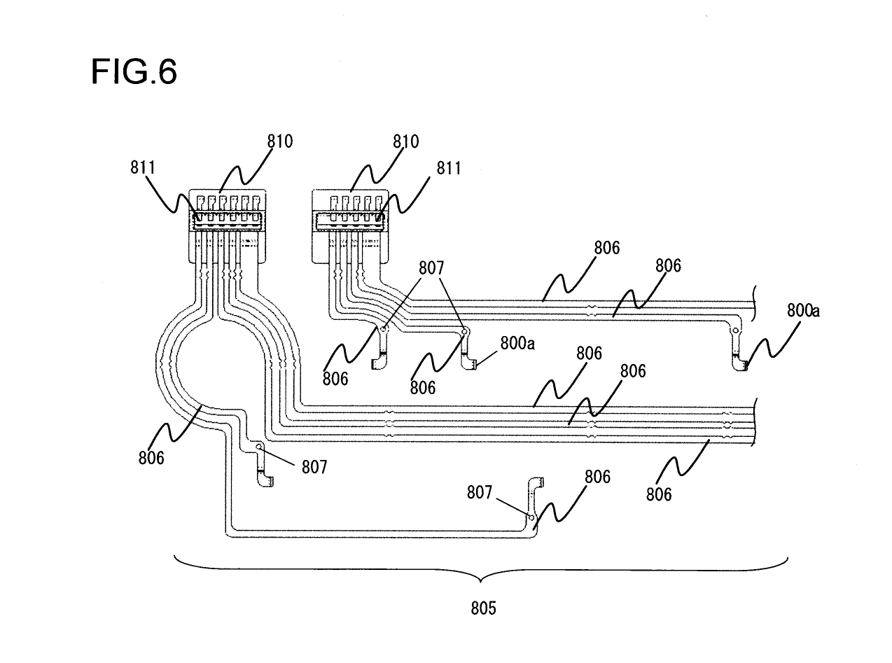

On the upper surface of the side plate 130, that is, the surface on the side of the inlet channel forming plate 111, two connection terminals 810 are provided in parallel in the longitudinal direction. The connection terminals 810 are molded of the same molding material as the side plate 130 integrally with the side plate 130, and placed on the upper surface of the side plate 130 on the side of the cooling medium inlet 114. Each connection terminal 810 includes a current breaking portion 811 (see FIG. 6), and electrically connects a wire (connection line) 800 extending from a voltage detection connector 912 of the control device 900 and the voltage detection conductor 805 described later via the current breaking portion 811. The voltage detection connector 912 is provided at each end of the control device 900 in the lateral direction. The connection lines 800 connected to the connection terminals 810 provided in the high potential battery block 100a are connected to the connector 912 of the control device 900 placed on the high potential battery block 100a. On the other hand, the connection lines 800 connected to the connection terminals 810 provided in the low potential battery block 100b are connected to the connector 912 of the control device 900 placed on the low potential battery block 100b. A length of each connection line 800 is set correspondingly to a distance from each connection terminal 810 to the corresponding connector 912 so as to prevent a wiring error. For example, the connection lines 800 connected to the connection terminals 810 of the high potential battery block 100a are set to be short enough not to reach the connector 912 of the low potential battery block 100b. Each current breaking portion 811 includes a fuse wire, and has a function of blowing in abnormality of the control circuit 900 or the wire 800 to break a current from the assembled battery 120 and protect a product.

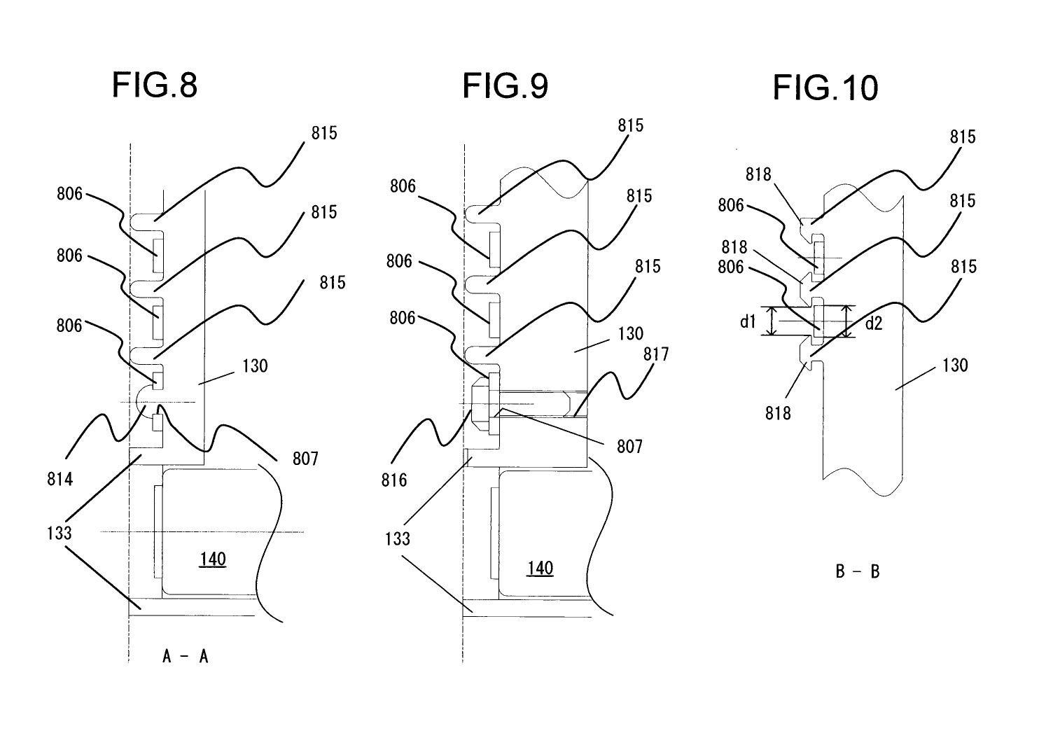

The voltage detection conductor 805 is connected to the conductive members 150 that connect the lithium ion battery cells 140 in series in order to detect a voltage of each of the plurality of lithium ion battery cells 140 that constitute the assembled battery 120. The voltage detection conductor 805 is placed on each of the side plates 130 and 131. FIG. 6 shows an example of a shape of the voltage detection conductor 805, and FIG. 7 is a partial enlarged view of the voltage detection conductor 805 shown in FIG. 6 placed on the side plate 130. FIGS. 8, 9 and 10 are cross-sections showing details of the voltage detection conductor 805 mounted to the side plate 130. The voltage detection conductor 805 placed on the side plate 130 and the voltage detection conductor 805 placed on the side plate 131 have the same configuration, and thus the voltage detection conductor 805 placed on the side plate 130 will be described below by way of example.

The voltage detection conductor 805 forms an elongated rectangular wire shaped detection lines 806 as shown in FIG. 6 by forming a thin plate of metal such as copper by pressing or the like. Specifically, the voltage detection conductor 805 is formed into a predetermined shape so as to include a plurality of detection lines 806 corresponding to the plurality of conductive members 150. The configuration of the voltage detection conductor 805 is not limited to the configuration shown in FIG. 6, and may be changed depending on specifications or the like.

The voltage detection conductor 805 is placed on the side plate 130, and each detection line 806 is attached to the side plate 130 by a method described later. Each tip 800a of the voltage detection conductor 805 is bent outward with respect to the housing chamber of the assembled battery 120 and connected to one of the conductive members 150. The other end opposite to the tips 800a of the voltage detection conductor 805 is electrically connected to one of the connection terminal 810 via the current breaking portion 811.

The shape of the voltage detection conductor 805 is designed to efficiently use an available space of the side plate 130 so as to reduce the size of the side plate 130 to reduce the size of the entire battery module 100. The plurality of lithium ion battery cells 140 are connected in series via the conductive members 150, and thus a potential difference is generated among the plurality of conductive members 150 to which the voltage detection conductor 805 is connected. Thus, in the voltage detection conductor 805, arrangement of the detection lines 806 are determined so as to minimize a potential difference between adjacent detection lines 806. Further, the walls 815 described later with reference to FIGS. 8 and 9 are provided between the detection lines 806 to prevent a short circuit.

As shown in FIG. 7, the voltage detection conductor 805 including the plurality of detection lines 806 is integrated with the side plate 130 by so-called outsert. FIGS. 8 and 9 show cross-sectional views taken along the line A-A in FIG. 7, and each show a method of securing the detection lines 806 to the side plate 130. As shown in FIG. 6, while the other ends of the voltage detection conductor 805 are connected to the current breaking portions 811, the detection lines 806 are separated from one another and are thus desirably secured to the side plate 130 in an appropriate manner.

Thus, in an example shown in FIG. 8, the side plate 130 has a protrusion 814 made of the same material as the side plate 130, and the protrusion 814 secures each detection line 806. Specifically, a hole 807 formed in each detection lines 806 in a position corresponding to the protrusion 814 is pressed on the protrusion 814 to secure the said detection line 806 to the side plate 130. As shown in FIG. 7, in each detection line 806, at least one hole 807 is provided near the tip 800a. Each tip 800a is electrically connected to one of the conductive members 150. Then, each detection line 806 and the side plate 130 are secured in a position near the tip 800a to reliably position the tip 800a and allow stable connection between the tip 800a and the conductive member 150. As such, in each detection line 806, at least one securing position to the side plate 130 is provided near the tip 800a. Two or more securing positions may be provided to allow each detection line 806 to be more stably secured to the side plate 130. In this case, for example, as shown in FIG. 7, a further hole 807 is provided near the current breaking portion 811 of each detection line 806 so that the protrusion 814 is pressed into the hole 807 for securing.

Each protrusion 814 provided on the side plate 130 is sized to be larger than the hole 807, thereby allowing the protrusion 814 and the hole 807 to be firmly secured. As a different securing method, the protrusion 814 may be sized to be smaller than the hole 807, and a tip of the protrusion 814 may be melted by heat and welded after the protrusion 814 is inserted into the hole 807.

As such, the voltage detection conductor 805 is secured to the side plate 130 to allow welding between the voltage detection conductor 805 and the conductive members 150, and stable connection between the voltage detection conductor 805 and the current breaking devices (current breaking portions) 811, thereby providing a reliable side plate 130.

The detection lines 806 are placed with an insulation creepage distance and with as narrow a pitch or a distance between the lines as possible for reducing the size of the side plate 130. Thus, as shown in FIG. 8, the walls 815 made of the same material as the side plate 130 are provided between the detection lines 806 in order to prevent a short circuit between the detection lines 806. Each wall 815 protrudes from the side plate 130, and as shown in FIG. 7, extends along the detection lines 806 between the detection lines 806. A height of each wall 815 from the side plate 130 is larger than a thickness of each detection line 806 and a height of each protrusion 814, and equal to a height of each peripheral wall 133 provided around the corresponding through hole 132 described above. The metal cover member 160 is first brought into contact with the walls 815 when deformed by an external force, thereby preventing a short circuit between the cover member 160 and the voltage detection conductor 805. As such, the walls 815 have a function of ensuring the insulation creepage distance required for the battery module 100 to prevent a short circuit between the detection lines 806, and preventing a short circuit between the cover member 160 and the detection lines 806.

FIG. 9 shows another example of a securing method of the detection lines 806 to the side plate 130. In this example, a female screw and a male screw provided in the side plate 130 are used. Specifically, as shown in FIG. 9, a bush 817 is previously inserted into the side plate 130, a male screw 816 is inserted into a hole 807 formed in each detection line 806 in a position corresponding to the bush 817 and the bush 817, and each detection line 806 is fastened to the side plate 130. Also in this case, each detection line 806 is secured to the side plate 130 in at least one position near the tip 800a. As in the securing method shown in FIG. 8, two securing positions may be provided near the tip 800a and the current breaking portion 811, respectively, thereby allowing each detection line 806 to be stably secured to the side plate 130.

Also when the securing method shown in FIG. 9 is adopted, in order to ensure insulation between the detection lines 806 and prevent a short circuit between the cover member 160 and the detection lines 806, walls 815 protruding from the side plate 130 are provided between the detection lines 806. A height of each wall 815 from the side plate 130 is larger than a thickness of the detection lines 806 and a height of a head of the male screw 816, and equal to the height of the peripheral walls 133 provided around the through holes 132 described above. Instead of the bush 817 being inserted into the side plate 130, the male screw 816 may be directly fastened into the side plate 130 as a resin material.

FIG. 10 is a sectional view taken along the line B-B in FIG. 7. With reference to FIG. 10, a method of securing the detection lines 806 in a position other than the securing position described above will be described. As shown in FIGS. 8 and 9, the securing position is provided near each tip 800a or the current breaking portion 811 to allow the detection lines 806 to be stably secured to the side plate 130. Preventing the detection lines 806 from being removed from the side plate 130 in a position other than the securing position allows the detection lines 806 to be more stably secured to the side plate 130.

Thus, as shown in FIG. 10, hook protrusions 818 made of the same material as the side plate 130 are formed on the side plate 130. The hook protrusion 818 can be configured by forming a tip of each wall 815 into a hook shape. A distance d1 between ends of two hook protrusions 818 in a width direction of each detection line 806 is smaller than a width d2 of the detection line 806. When each detection line 806 is pressed between the hook protrusions 818 to place the voltage detection conductor 805 on the side plate 130, the detection line 806 is not removed from the side plate 130 since the width d2 of the detection line 806 is larger than the distance d1 between the ends of the hook protrusions 806. The hook protrusions 818 are placed in required positions on the side plate 130 other than the securing positions described above, thereby allowing the voltage detection conductor 805 to be stably placed on the side plate 130.

In the securing method of the voltage detection conductor 805 in FIGS. 8 to 10, soft resin such as an adhesive may be applied after securing to seal the voltage detection conductor 805. This can prevent a short circuit of the voltage detection conductor 805 by foreign substance, and prevent corrosion of the voltage detection conductor 805.

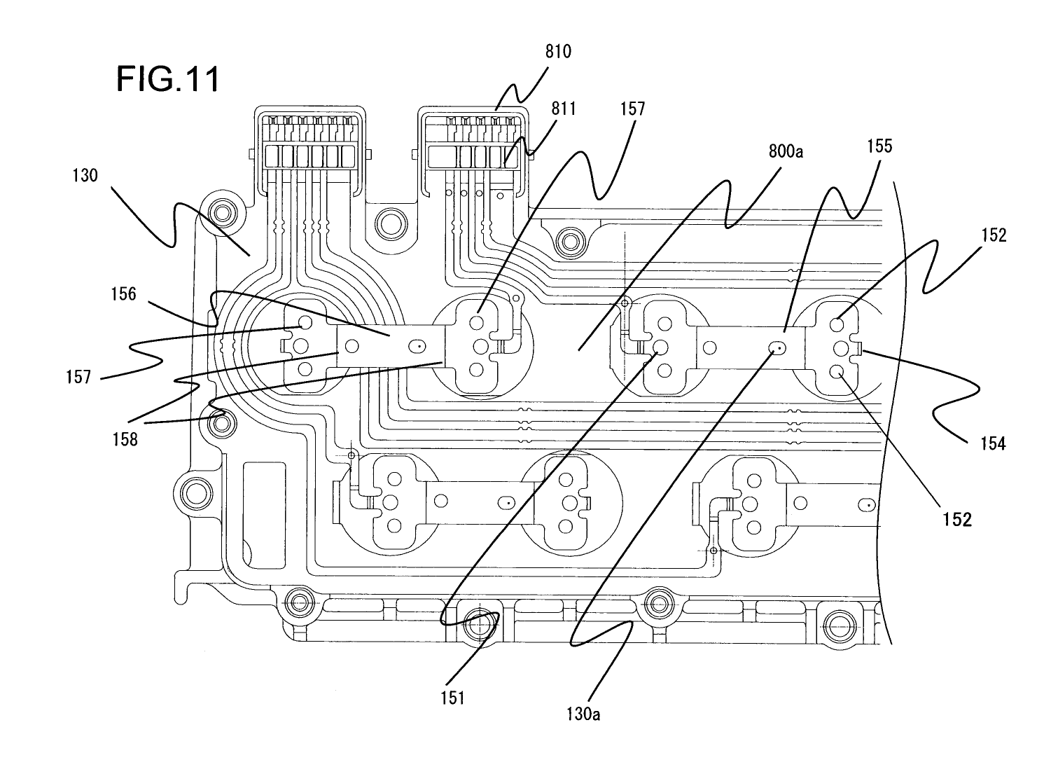

FIG. 11 shows a state where the conductive members 150 are mounted to the side plate 130, which is provided with the voltage detection conductor 805, and connected to the lithium ion battery cell 140. Each conductive member 150 is a plate member of metal, for example, copper, that electrically connects between the lithium ion battery cells 140, and configured separately from the side plate 130. However, as shown in FIG. 5, a conductive member 150a integrally formed with the connection terminal 180 and a conductive member 150b integrally formed with the connection terminal 181 are integrally formed with the side plate 130.

Each conductive member 150 includes a middle portion 156 extending in a strip shape, and ends 157 at opposite ends of the middle portion 156. The middle portion 156 and the ends 157 are continuous via bent portions 158. Specifically, the conductive member 150 is bent and formed into a step shape. Each end 157 of the conductive member 150 has a through hole 151, joining areas 152 to the terminal surface of the corresponding lithium ion battery cell 140, and a welding area 154 to be connected to the tip 800a of the corresponding voltage detection conductor 805. The through hole 151 is provided so that when a gas is ejected from the lithium ion battery cell 140 as described above, the ejected gas passes through the through hole 151. The middle portion 156 of the conductive member 150 has at least one through hole 155 through which the securing guide 130a provided on the side plate 130 is inserted. The through hole 155 may have an oval or circular shape.

Each conductive member 150 is mounted to the side plate 130 so that at least one through hole 155 in the middle portion 156 fits at least one securing guide 130a provided on the side plate 130. When the conductive members 150 are mounted to the side plate 130, the opposite ends 157 of each conductive member 150 fit in the corresponding through holes 132 and abut against the terminal surfaces of the lithium ion battery cells 140. The welding area 154 of the conductive member 150 abuts against the tip 800a of the corresponding voltage detection conductor 805. Because of a connection structure to the lithium ion battery cells 140, the tips 800a are not placed at some of the through holes 132.

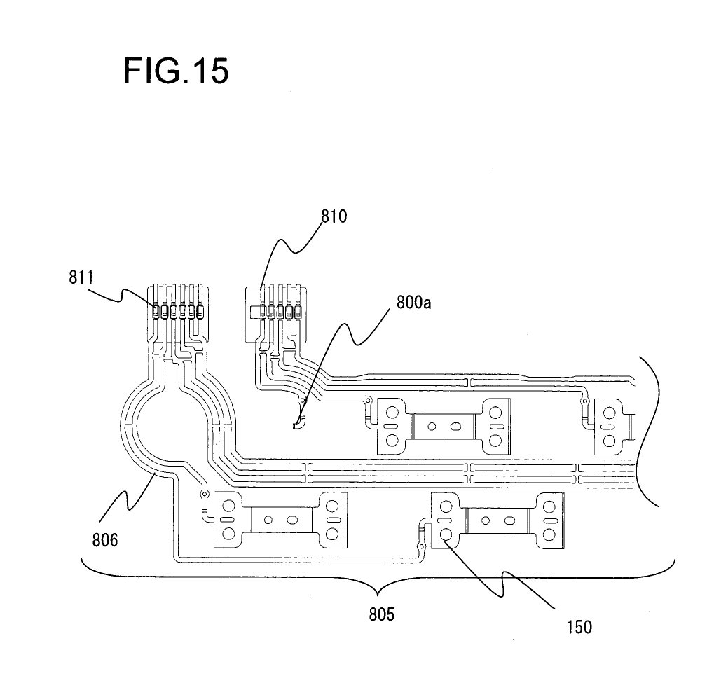

When the voltage detection conductor 805 is secured in a manner as shown in FIGS. 8 to 10, the voltage detection conductor 805 and several conductive members 150 may be integrally molded as shown in FIG. 15.

Next, the control device 900 included in the lithium ion battery device 1000 will be described. As shown in FIGS. 2 and 3, the control device 900 is placed on the battery module 100. Specifically, the control device 900 is an electronic circuit device placed over the high potential battery module 100a and the low potential battery module 100b, and includes a case 910 and one circuit board housed in the case 910.

The case 910 is a flat rectangular parallelepiped box made of metal, and secured to the high potential battery module 100a and the low potential battery module 100b by securing means such as a bolt or a screw. Thus, the high potential battery module 100a and the low potential battery module 100b are connected and secured at ends in the lateral direction by the control device 900. Specifically, the control device 900 also functions as a support, thereby further increasing strength of the battery module 100.

A plurality of connectors are provided on a side surface of the case 910, that is, on opposite end surfaces of the control device 900 in the lateral direction. The plurality of connectors include the voltage detection connectors 912, a temperature detection connector 913, and an external connection connector 911. To the voltage detection connectors 912, connectors of the connection lines 800 electrically connected to thirty-two lithium ion battery cells 140 are connected. To the temperature detection connector 913, connectors of signal wires of a plurality of temperature sensors (not shown) placed in the battery module 100 are connected.

To the external connection connector 911, connectors (not shown) of a power supply line for supplying driving power to the battery controller 300, a signal wire for inputting on/off signals of an ignition key switch, and a communication line for CAN communication with the vehicle controller 30 or the motor controller 23 are connected.

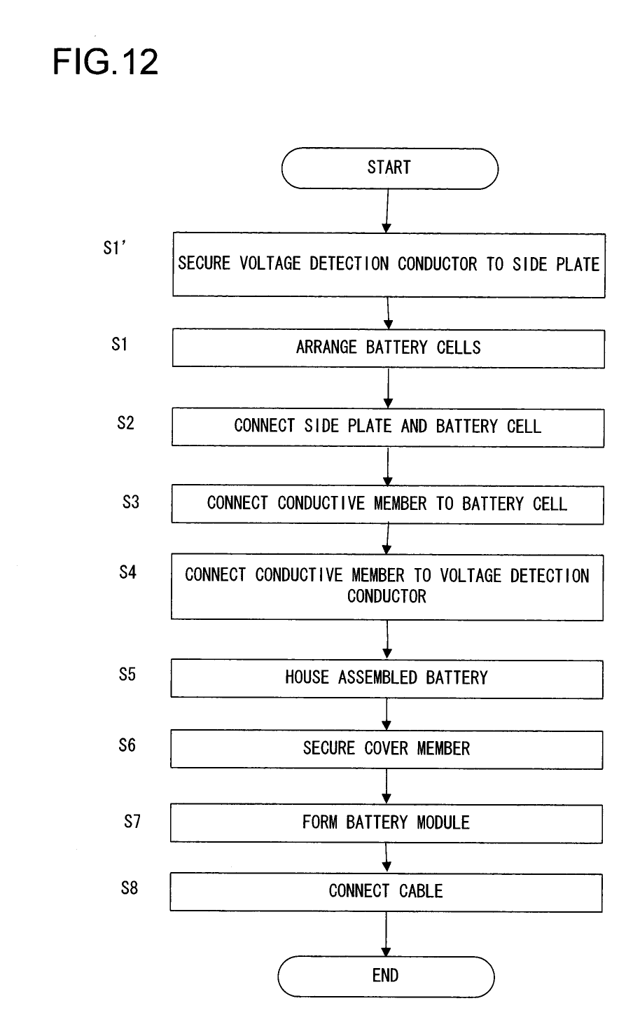

A production method, particularly, an assembling method of the lithium ion battery device 1000 constituted by the battery module 100 and the control device 900 described above will be described with reference to a flowchart in FIG. 12.

First, in Step S1′, the voltage detection conductor 805 is mounted and secured to the side plates 130 and 131 by the method shown in FIG. 8 or 9. The voltage detection conductor 805 is previously formed into a predetermined shape, and placed on the side plates 130 and 131 so that each tip 800a corresponds to the position of the corresponding conductive member 150.

Then, in Step S1, assembling of the high potential battery block 100a and the low potential battery module 100b is started. The inlet channel forming plate 111, the outlet guide plate 113, the cooling medium inlet 114, and the cooling medium inlet duct 116 are integrally formed with the outlet channel forming plate 118, the inlet guide plate 112, the cooling medium outlet 115, and the cooling medium outlet duct 117. The assembly thus integrated is secured via a seal member (not shown) to one of the side plates 130 and 131, for example, the side plate 130 by securing means such as a bolt, a screw, or a rivet, and placed with the side plate 130 facing down.

In step S2, each lithium ion battery cell 140 is assembled to the side plate 130 using an adhesive (adhesive member). The adhesive has appropriate flexibility, and has a function of bonding the side plate 130 and the lithium ion battery cells 140 and a function of sealing between the both. The adhesive having flexibility is used to ensure airtightness and liquid tightness between the cooling passage inside the casing 110 including the side plate 130 and the gas release chamber outside the casing 110. Also, even if, for example, vibration is applied to the battery module 100, the vibration can be absorbed by the adhesive and a connection state between the side plate 130 and the lithium ion battery cell 140 can be maintained. As the adhesive member, a liquid gasket having the above function may be used.

In step S3, the side plate 131 is attached to the assembly formed in step 2 using an adhesive (adhesive member) as in step 2. Then, as in step 1, the assembly is secured to the side plate 131 by securing means such as a bolt, a screw, or a rivet. Thus, the assembled battery 120 is housed in the casing 110.

In step S4, each lithium ion battery cell 140 and the corresponding conductive member 150 are connected. First, as shown in FIG. 11, a through hole 155 in the conductive member 150 is fitted on the securing guide 130a on one of the side plates 130 and 131, for example, the side plate 130 to mount each conductive member 150 to the side plate 130. Then, the welding areas 152 of each conductive member 150 are joined to a terminal surface of a corresponding lithium ion battery cell 140 by TIG welding. Similarly, the conductive members 150 are also mounted to the other of the side plates 130 and 131, that is, the side plate 131 to join the welding areas 152 of the conductive members 150 and the lithium ion battery cells 140 by TIG welding.

Then in step S5, each conductive member 150 and the tip 800a of each voltage detection conductor 805 are connected. Specifically, the welding area 154 of the conductive member 150 is abutted against the tip 800a of the corresponding voltage detection conductor 805, and the welding area 154 and the tip 800a are joined by TIG welding.

In step S6, the cover member 160 is assembled to each of the side plates 130 and 131 via a seal member 135 (see FIG. 5), and secured by securing means 161 such as a bolt, a screw, or a rivet. The seal member 135 is an annular elastic seal member (for example, a rubber O-ring), and fitted into a groove 134 formed in the side plate 130. A liquid gasket may be used as the seal member 135.

Then in step S7, two assemblies (battery blocks 100a and 100b) produced in step S6 are placed so that longitudinal directions of the assemblies are parallel to each other, and the module base 101 is assembled to the battery blocks 100a and 100b with the two battery blocks 100a and 100b placed in parallel. The module base 101 is secured to a bottom of the casing 110 by securing means such as a bolt, a screw, or a rivet. The case of the control device 900 is secured to a middle portion in the longitudinal direction of the two battery blocks 100a and 100b by securing means such as a bolt, a screw, or a rivet. Thus, the battery module 100 is formed.

An assembling order of the components that constitute the battery module 100 is not limited to the above, and a securing order of the components may be changed.

Next, in step S8, the connectors of the connection lines 800 are connected to the connection terminals 810 of the battery module 100 and the connectors 912 of the control device 900. Connectors of signal wires extending from a plurality of temperature sensors (not shown) provided in the battery blocks 100a and 100b of the battery module 100 are connected to the connector 913 of the control device 900. Further, a connector of a communication line for communication with a host control device, for example, the vehicle controller 30 and the motor controller 23, is connected to the connector of the control device 900.

By the assembling operations in steps S1′ to S8 above, the lithium ion battery device 1000 is completed.

### —Variant—

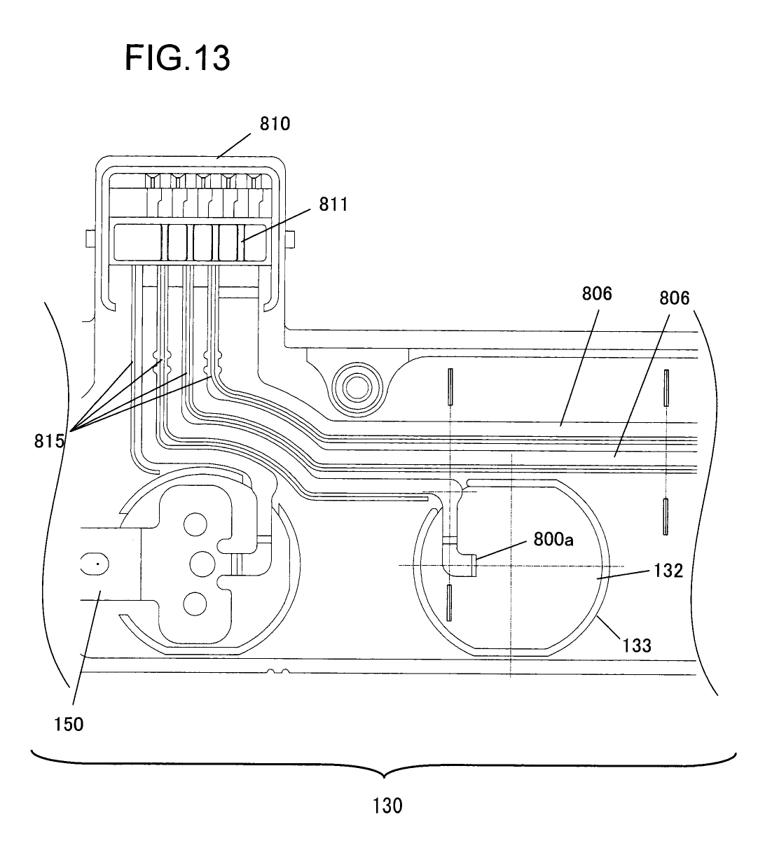

(1) In the embodiment described above, the detection lines 806 of the voltage detection conductor 805 are secured to each of the side plates 130 and 131 using the holes 807, and the protrusions 814 (see FIG. 8) or the male screws 816 (see FIG. 9). However, not limited to this, as shown in FIG. 13, the voltage detection conductor 805 may be simply placed on each of the side plates 130 and 131. In this case, there is no need for the hole 807 provided in the detection line 806. The hook protrusions 818 shown in FIG. 10 may be omitted. Even with such a configuration, the tips 800a of the voltage detection conductor 805 are connected to the welding areas 154 of the conductive members 150, and the other ends are connected to the current breaking portions 811, thereby ensuring minimum necessary positioning on the side plates 130 and 131. If an insulation creepage distance between the detection lines 806 is ensured, the wall 815 provided between the detection lines 806 may be omitted.

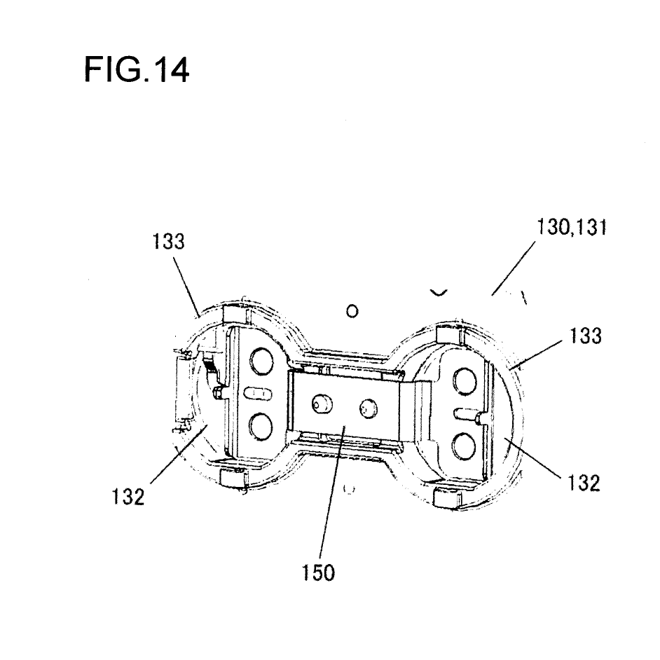

(2) In the embodiment described above, for example, as shown in FIG. 7, the peripheral wall 133 is provided so as to surround each through hole 132 provided on the side plates 130 and 131. However, the shape of the peripheral wall 133 is not limited to this, but for example, as shown in FIG. 14, the peripheral wall 133 may surround the entire conductive member 150. In this case, the peripheral wall 133 surrounds the through holes 132, and also extends along the middle portion 156 of the conductive member 150 between the two through holes 132. The height of each peripheral wall 133 from the side plates 130 and 131 is preferably equal to the height of each wall 815. Thus, even if the cover member 160 is deformed by an external force, the cover member 160 is first brought into contact with the peripheral walls 133, thereby reliably preventing a short circuit between the cover member 160 and the conductive members 150. It is to be noted that the shape of the conductive member 150 shown in FIG. 14 is slightly different from the shape of the conductive member 150 shown in FIG. 11.

With the electric storage module (battery module 100) according to the embodiment and the variants described above, the following operation and effect can be obtained.

(1) The battery module 100 includes the plurality of electric storage cells 140, the case (casing) 110 housing the plurality of electric storage units 140, the plurality of conductive members 150 for electrically connecting the plurality of electric storage units 140, and the voltage detection conductor 805 for detecting the voltage of each of the plurality of electric storage units 140. The case 110 includes the pair of resin side plates 130 and 131 that hold and support at least the plurality of electric storage units 140 from opposite sides. As shown in FIG. 13, the voltage detection conductor 805 is formed correspondingly to positions of the plurality of conductive members 150 and placed on the side plates 130 and 131. When the voltage detection conductor 805 is mounted to the side plates 130 and 131, the voltage detection conductor 805 previously formed into a predetermined shape may be simply placed on the side plates 130 and 131, thereby facilitating a mounting operation. The voltage detection conductor 805 is previously formed so as to ensure an insulation creepage distance of the battery module 100. This can provide the side plates 130 and 131 with low cost, small size, and high quality.

(2) The battery module 100 further includes the securing device for securing the voltage detection conductor 805 and the side plates 130 and 131. Thus, the voltage detection conductor 805 can be reliably secured to the side plates 130 and 131.

(3) Specifically, the securing device includes the protrusions 814 provided on the side plates 130 and 131, and the holes 807 formed in the voltage detection conductor 805 in the position corresponding to the protrusion 814 (see FIG. 8). Each protrusion 814 can be fitted into the corresponding hole 807 to secure the voltage detection conductor 805 and the side plates 130 and 131, thereby facilitating a mounting operation.

(4) As another example of the securing method, the securing device includes the female screw provided in the side plates 130 and 131, and the hole 807 formed in the voltage detection conductor 805 in the position corresponding to the female screw (see FIG. 9). The male screw 816 can be screwed into the female screw 817 via the hole 807 to secure the voltage detection conductor 805 and the side plates 130 and 131, thereby facilitating a mounting operation.

(5) The battery module 100 further includes the metal cover member 160 that covers the casing 110 on the outside of each of the side plates 130 and 131. As shown in FIG. 7, on the side plates 130 and 131, the walls 815 extending along the voltage detection conductor 805 are provided to protrude from the side plates 130 and 131. As shown in FIGS. 8 and 9, the height of the walls 815 from the side plates 130 and 131 is larger than the thickness of the voltage detection conductor 805 and smaller than the distance from the side plates 130 and 131 to the cover member 160. As such, the walls 815 protrude from the voltage detection conductor 805, thereby reliably maintaining the shape of the voltage detection conductor 805, and preventing accidental contact between the detection lines 806 of the voltage detection conductor 805 in a production process. Specifically, a short-circuit potential in the voltage detection conductor 805 is reduced. Further, even if the cover member 160 is deformed, the cover member 160 is brought into contact with the wall 815 earlier than the voltage detection conductor 805, thereby preventing a short circuit between the cover member 160 and the voltage detection conductor 805. If the conductive member 150 is covered with soft resin, cover member 160 is not brought into contact with the conductive member 150 even if deformed.

(6) As shown in FIG. 14, the peripheral wall 133 protruding from the side plates 130 and 131 is provided so as to surround each conductive member 150, and thus even if the cover member 160 is deformed by an external force, a short circuit between the cover member 160 and the conductive member 150 can be prevented. The peripheral wall 133 surrounds the entire conductive member 150 except near the tip 800a and thus can bear various external forces.

(7) The height of each peripheral wall 133 from the side plates 130 and 131 is substantially equal to the height of each wall 815 from the side plates 130 and 131. This can reliably prevent contact between the cover member 160, and the voltage detection conductor 805 and the conductive member 150. The securing guides 130a, the peripheral walls 133, the walls 815, and the hook protrusions 818 provided on the side plates 130 and 131 function as a collision preventing mechanism for preventing contact between the cover member 160, and the voltage detection conductor 805 and the conductive members 150. For example, if the cover member 160 is deformed inward of the casing 110 by an external force, the cover member 160 is first brought into contact with the securing guides 130a, the peripheral walls 133, the walls 815, and the hook protrusions 818 protruding from the surfaces of the side plates 130 and 131. This can prevent contact between the cover member 160, which is made of, for example, iron, and the conductive members 150 and the voltage detection conductor 805 to cause a short circuit.

(8) The plurality of conductive members 150 are mounted to the side plates 130 and 131 from outside the casing 110 for connecting the plurality of electric storage units 140. This facilitates connection between the conductive member 150 and each storage battery 140. In the embodiment described above, the conductive members 150 and the corresponding lithium ion battery cells 140 are joined by TIG welding.

(9) The tips 800a of the voltage detection conductor 805 are connected to the plurality of conductive members 150, and the current breaking device (current breaking portion) 811 that breaks the current from the electric storage units 140 is provided at the other end of the voltage detection conductor 805. The current breaking portion 811 causes the fuse wire to blow in abnormality of the control circuit 900 and the wire 800 to break the current from the assembled battery 120, thereby protecting a product. The current breaking portion 811 is provided at the other end of the voltage detection conductor 805, and thus for example, when a short circuit occurs in the wire 800, the current breaking portion 811 breaks the current at the other end of the voltage detection conductor 805. This can protect the entire battery module 100. In this case, the wire 800 and the current breaking portion 811 can be replaced to allow reuse of the battery module 100.

(10) The side plates 130 and 131 have the through holes 132 in the positions corresponding to the plurality of electric storage units 140, and the plurality of electric storage units 140 are mounted to the side plates 130 and 131 using an adhesive member so as to tightly close the through holes 132. Thus, a seal can be provided between the inside and the outside of the casing 110. A connection state between the side plates 130 and 131 and the electric storage units 140 can be maintained, with the external force, for example, vibration applied to the battery module 100 being absorbed by the adhesive member.

(11) The electric storage device (lithium ion battery device) 1000 includes the battery module 100, and the control device 900 that is connected to the voltage detection conductors 150 to detect the voltage of the plurality of electric storage units 140 and control an electric storage amount of the plurality of electric storage units 140.

(12) In case where the voltage detection conductor 805 and the conductive members 150 are integrally formed, there is no need for welding, thereby increasing reliability.

Further, in the embodiment described above, as described with reference to FIGS. 8 and 9, the voltage detection conductor 805 formed into the predetermined shape is attached with the side plates 130 and 131 by welding, screw securing, or fitting, but the attaching or integrating method of the voltage detection conductor 805 and the side plates 130 and 131 is not limited to this. The number of the holes 807 provided in the detection lines 806 is not limited to the embodiment described above.

In the embodiment described above, the battery module 100 is exemplified including the two battery blocks 100a and 100b in each of which the sixteen lithium ion battery cells 140 are connected. However, the present invention is not limited to the configuration or a connection type (series or parallel) of the battery module 100 described above, but may be applied to configurations with a different number of lithium ion battery cells 140, a different number of battery cell rows, different arrangement, or different directions.

In the embodiment described above, the cylindrical battery is exemplified as the lithium ion battery cell 140, but the present invention is not limited to this. For example, the present invention is also applied to a lithium ion battery cell 140 of a rectangular storage battery or a laminate seal battery, and batteries other than the lithium ion battery such as a nickel hydrogen battery.

The electric storage device 1000 according to the embodiment described above may be used in a vehicle power supply device of other electric vehicles, for example, a railway vehicle such as a hybrid train, a passenger automobile such as a bus, a cargo automobile such as a truck, an industrial vehicle such as a battery type forklift truck.

The electric storage device 1000 according to the embodiment may be applied to an electric storage device that constitutes a power supply device of other than an electric vehicle such as an uninterruptible power supply device used in a computer system or a server system, or a power supply device used in private power generation equipment.

According to the embodiment described above, an electric storage module and an electric storage device including a side plate with low cost and high reliability can be provided.

The above described embodiments are examples, and various modifications can be made without departing from the scope of the invention.

What is claimed is:

1. An electric storage module comprising:
a plurality of electric storage units;
a casing that houses the plurality of electric storage units;
a plurality of conductive members that electrically connect the plurality of electric storage units; and
a voltage detection conductor that detects a voltage of each of the plurality of electric storage units, wherein:
the casing includes a pair of resin side plates that hold and support at least the plurality of electric storage units from opposite sides, and
the voltage detection conductor is formed so as to correspond to positions of the plurality of conductive members and placed on each of the side plates.

2. The electric storage module according to claim 1, further comprising:
a securing device that secures the voltage detection conductor and each of the side plates.

3. The electric storage module according to claim 2, wherein:
the securing device includes a protrusion provided on each of the side plates, and a hole formed in the voltage detection conductor in a position corresponding to the protrusion, and the protrusion is fitted into the hole to secure the voltage detection conductor and a corresponding side plate.

4. The electric storage module according to claim 2, wherein:
the securing device includes a female screw provided in each of the side plates, and a hole formed in the voltage detection conductor in a position corresponding to the female screw, and the male screw is screwed into the female screw via the hole to secure the voltage detection conductor and a corresponding side plate.

5. The electric storage module according to claim 1, further comprising:
a metal cover member that covers the casing on an outside of the pair of side plates; and
a wall protruding from each of the side plates and extending along the voltage detection conductor,
wherein a height of the wall from a corresponding side plate is larger than a thickness of the voltage detection conductor and smaller than a distance from the corresponding side plate to the cover member.

6. The electric storage module according to claim 1, further comprising:
a peripheral wall protruding from each of the side plates so as to surround each of the plurality of conductive members.

7. The electric storage module according to claim 5, further comprising:
a peripheral wall protruding from each of the side plates so as to surround each of the plurality of conductive members,
wherein a height of the peripheral wall from a corresponding side plate is substantially equal to a height of the wall from the corresponding side plate.

8. The electric storage module according to claim 1, wherein:
the plurality of conductive members are mounted to each of the side plates from outside the casing for connecting the plurality of electric storage units.

9. The electric storage module according to claim 1, wherein:
a tip of the voltage detection conductor is connected to each of the plurality of conductive members, and
a current breaking device that breaks a current from the electric storage units is provided in the voltage detection conductor.

10. The electric storage module according to claim 1, wherein:
through holes are formed in each of the side plates in positions corresponding to the plurality of electric storage units, and
the plurality of electric storage units are mounted to the side plates using an adhesive member so as to tightly close the through holes.

11. The electric storage module according to claim 3, wherein:
the voltage detection conductor secured to each of the side plates is covered with soft resin.

12. The electric storage module according to claim 1, wherein:
the voltage detection conductor and the conductive members are integrated.

13. An electric storage device comprising:
an electric storage module according to claim 1; and
a control device that is connected to the voltage detection conductor to detect a voltage of the plurality of electric storage units and control an electric storage amount of the plurality of electric storage units.
